(19) United States
(12) Patent Application Publication
(10) Pub. No.: US 2011/0130790 A1
(43) Pub. Date: Jun. 2, 2011

(54) Pacifier

(75) Inventors: Reza Hezari, Trondheim (NO); Terje S. Pedersen, Sandnes (NO); Bjørn Øgaard, Oslo (NO)

(73) Assignees: Reza HEZARI; Terje S. PEDERSEN

(21) Appl. No.: 13/055,361

(22) PCT Filed: Jul. 22, 2009
(86) PCT No.: PCT/NO09/00269

§ 371 Date: Feb. 15, 2011

(30) Foreign Application Priority Data
Jul. 22, 2008 (NO) 20083238

(51) Int. Cl. A61J 17/00

(52) U.S. Cl. 606/234

(57) ABSTRACT

A pacifier (1) comprising a bladder body (2) and a stop disc (4) interconnected by a transition and connection portion (6), as the bladder body (2) is shaped with an asymmetric, in the user position against a tongue (22) of a child (14) concave portion (24) and comprising a branch (18) sloping downward and inward and a bladder part (20) directed upward and inward, where at least the bladder part (20) is provided with a cavity, and wherein the bladder part (20) comprises a tongue plate (28) and a palate plate (30) where the tongue plate (28) and the palate plate (30) are interconnected along their edge portion in a bulb (32).

This invention relates to a pacifier. More particularly it concerns a pacifier comprising a bladder body and a stop disc interconnected by a transition and connection portion, as the bladder body is shaped with an asymmetric, in the user position against a child tongue, concave portion comprising a branch sloping downward and inward and a bladder part directed upward and inward, where at least the bladder part is provided with a cavity.

Pacifiers of traditional design are formed having a relatively large bladder body. This relatively large bladder body occupies a considerable part of the palate area and causes thereby that the child tongue during use of a pacifier of this sort does not abut the palate, but takes up an abnormal position in the mouth.

Studies have shown that this abnormal position can affect the development of the lower jaw of the child negatively by a so-called malocclusion. Such a form of jaw defect is unfortunate and inflicts unnecessary stress on the child during subsequent treatment.

Norwegian patent 302926 deals with a pacifier, which is formed to overcome this problem. The pacifier bladder body is connected to a transition and connection portion and is, in the user position, in side view formed as a curved, perhaps doubly curved, plate-like element comprising two bladder portions having different lengths, one relatively long, lower bladder part merging into a considerably shorter, upper bladder part being angled relative to the longer bladder part. This shape prevents the tongue from being forced down and forward against the lower jaw.

Tests have shown that the arrangement of NO 302926 has insufficient bladder area for children during the first months of life as children in this age group prefer to suck a larger body. Habituation to an asymmetric pacifier may in addition be demanding.

The object of the invention is to mitigate or reduce at least one of the prior art drawbacks.

The object is achieved according to the invention by the features stated in the below description and in the following claims.

There is provided a pacifier comprising a bladder body and a stop disc which are interconnected by a transition and connecting portion, as the bladder body is shaped with an asymmetric, in the user position against a child tongue, concave portion comprising a branch sloping downward and inward and a bladder part directed upward and inward, where at least the bladder part is provided with a cavity. The pacifier is characterised by that the bladder part comprising a tongue plate and a palate plate wherein the tongue plate and the palate are interconnected in a bulb along their edge portions.

By forming the pacifier bladder body with a relatively long, referred to the user position, in side view, upward and inward in the oral cavity of a child extending relatively flat bladder part and a shorter and inward extending plate-shaped branch, it has turned out that the need of an infant for a larger body to suck may be combined with retaining the favourable features achieved according to NO 302926.

Said bladder part abuts during use the forward portion of the palate as the tip of the baby tongue abuts a concave portion formed between the bladder part and the branch. The branch extends down between the lower jaw and the tongue of the infant, and causes the pacifier bladder body to lie stably in the oral cavity at the same time as the tongue may maintain a chiefly normal position. The tongue thereby prevents that the pacifier is drawn into the mouth, which may influence the position of the front teeth when employing traditionally shaped pacifiers, as the front teeth in the upper jaw are forced outward and the front teeth in the lower jaw are forced inward.

Getting used to an asymmetric pacifier is facilitated further by the upward and inward directed bladder part being formed with a relatively thin tongue plate in the shape of a wall arranged to be able to abut the tongue, and a palate plate in the shape of a wall arranged to be able to abut the palate. The tongue and palate plates are positioned on opposite sides of the pacifier cavity.

The tongue and palate plates are as mentioned interconnected in a bulb along their edge portions.

The fairly thin tongue plate is relatively easily displaceable relative to the palate plate, and the child will therefore during use be able to feel a response on its sucking effort, which turns out to have a favourable effect in the habituation period. The tongue plate may have a smaller thickness than the palate plate.

Experience has shown that relatively thin walls in pacifiers are exposed to damage in the form of bites. By connecting the tongue plate and the palate plate in a bulb along their edge portions will the bulb, which may have a larger thickness than the total thickness of the tongue plate and the palate plate, be able to moderate bites on the bladder part and thereby prevent the tongue plate from being penetrated.

Each of the branch and the bladder part may be approximately flat or be given a relatively mild curvature.

There is provided a pacifier, which is particularly suitable for infants during habituation for a pacifier. The pacifier causes, during use, that the tongue is held in a favourable position in the mouth such that the danger of child developing malocclusion is reduced.

In the following is described an example of a preferred embodiment which is illustrated in the accompanying drawings, wherein:

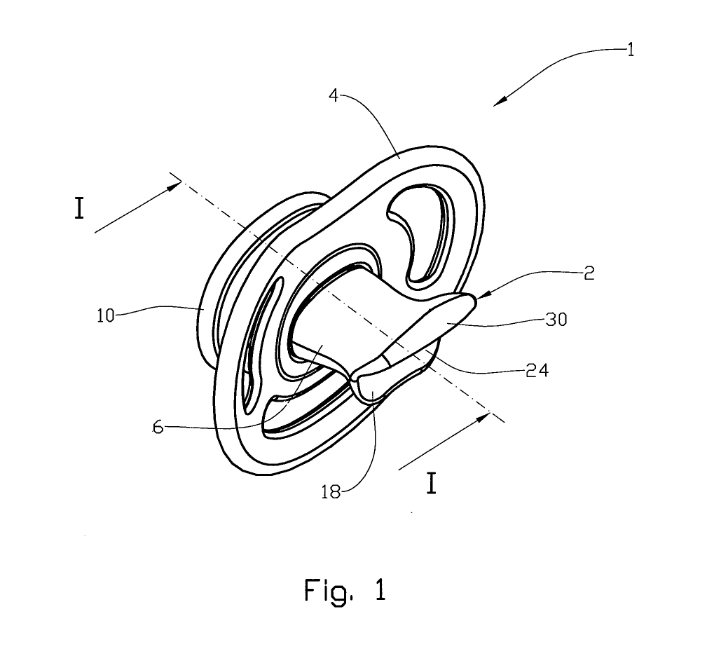

FIG. 1 shows a perspective view of a pacifier of the invention;

FIG. 2 shows a cross-section I-I in FIG. 1;

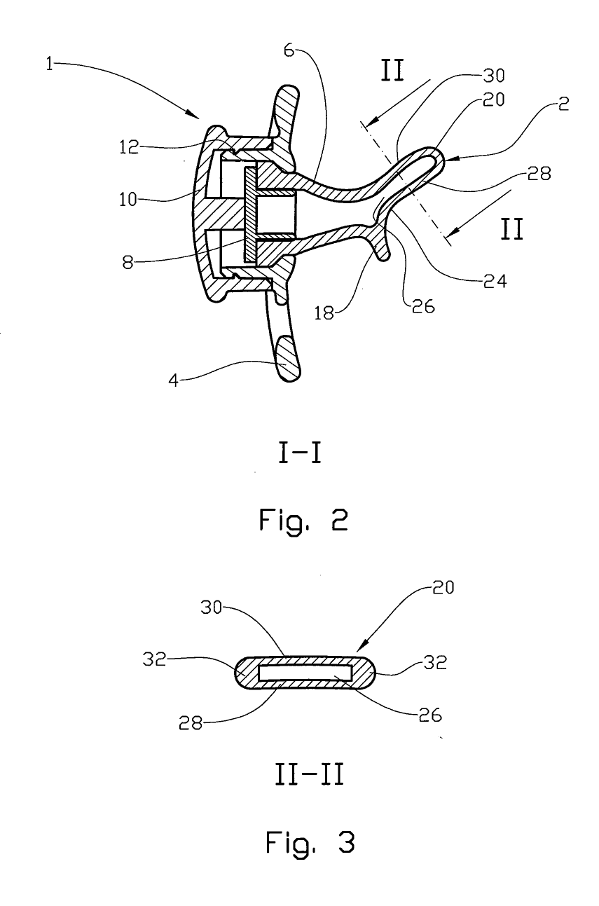

FIG. 3 shows a cross-section II-II in FIG. 2; and

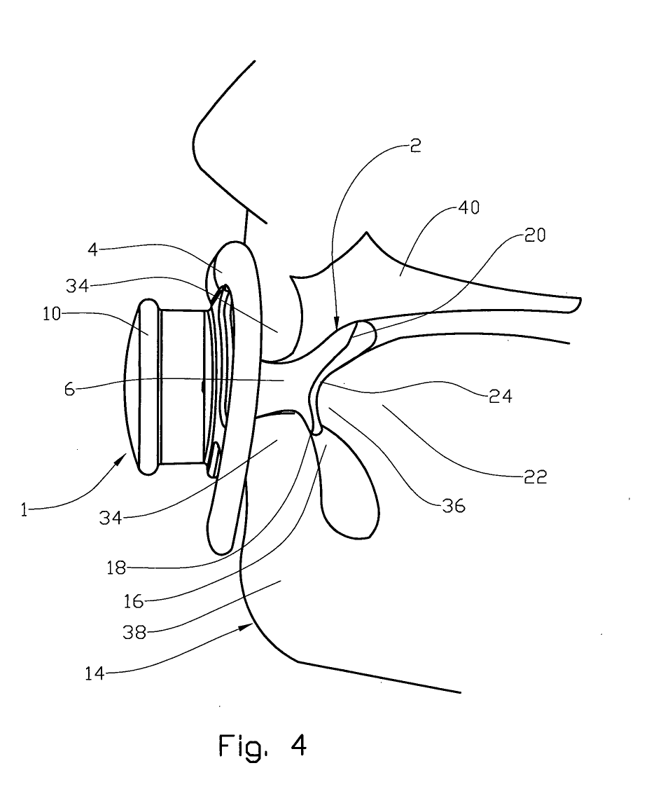

FIG. 4 shows schematically the pacifier in a position of use.

In the drawings the reference numeral 1 indicates a pacifier, which comprises a bladder body 2 connected to a stop disc 4 via an intermediate transition and connecting portion 6. The transition and connecting portion 6 is locked in the stop disc 4 by means of a lock 8 being held in position by a grip 10, see FIG. 2. The grip 10 is connected to the stop disc by a notch/hook coupling 12.

The stop disc 4 is arranged to prevent the entire pacifier 1 getting into the oral cavity 16 of a child 14, see FIG. 4.

The bladder body 2 comprises, referred to a user position, see FIGS. 2 and 4, a from the transfer and connecting portion 6 relatively short, downward and inward in the oral cavity 16 extending plate-like branch 18 and a somewhat longer hollow, upward and inward extending bladder part 20.

The branch 18 and the bladder part 20 have a mutually smooth transition and forms together the bladder body 2. The bladder body 2 has a concave portion 24 facing toward the child's 14 tongue 22. The bladder body 2 exhibits a somewhat edged contour as seen from the tongue side.

The cavity 26 in the bladder part 20 runs through the transfer and connecting portion 6 and may be open or closed to the surroundings.

The bladder part 20 comprises a tongue plate 28 and an on the opposite side of the cavity 26 being palate plate 30, see FIGS. 2 and 3. The tongue plate 28 and the palate plate 30 are interconnected by a bulb 32 running along the edge portions of the tongue plate 28 and the palate plate 30.

In this preferred embodiment example the bulb 32 has a larger thickness than the total thickness of the tongue plate 28 and the palate plate 30.

When the bladder body 2 of the pacifier 1 is in user position in the oral cavity 16 of the child 14, see FIG. 4, the transfer and connecting portion 6 extends from the stop disc 4, between the gums 34 of the child 14 and in to the bladder body 2. The tongue tip 36 of the child 14 is positioned in the concave portion 24 of the bladder body 2.

The branch 18 extends in between the lower jaw 38 and the tongue 22 of the child 14, and causes the tongue 22 to maintain mainly its natural position in the oral cavity 16 of the child 14. The bladder part 20 extends in between the palate 40 and the tongue 22 of the child 14.

The relatively thin tongue plate 28 is easily displaceable and is thereby displaced by the tongue 22 when the child 14 sucks the pacifier 1. This elastic displacement of the tongue plate 28 contributes to the child 14 noticing a response to the sucking action, which affects the habituation process to the pacifier 1 favourably.

1. A pacifier comprising:
a bladder body; and
a stop disc which are interconnected by means of a transition and connecting portion, as the bladder body is formed with an asymmetric, in the user position against a tongue of a child, concave portion, and comprising a branch sloping downward and inward and a bladder part directed upward and inward, where at least the bladder part is provided with a cavity, wherein the bladder part comprises a tongue plate and a palate plate where the tongue plate and the palate plate are connected together along their edge portions in a bulb.

2. The pacifier according to claim 1, wherein the tongue plate has a larger thickness than the palate plate.

3. The pacifier according to claim 1, wherein the bulb has a larger thickness than the tongue plate and the palate plate thickness put together.

4. The pacifier according to claim 1, wherein the branch is nearly flat.

5. The pacifier according to claim 1, wherein the bladder part is nearly flat.
